(19) United States
(12) Patent Application Publication
(10) Pub. No.: US 2015/0309502 A1
(43) Pub. Date: Oct. 29, 2015

(54) MANAGING PROVENANCE AND AUTHENTICITY FOR DIGITALLY MANUFACTURED OBJECTS

(71) Applicant: International Business Machines Corporation, Armonk, NY (US)

(72) Inventors: David Breitgand, Modiin (IL); David Kohen, Tuval (IL); Oded Margalit, Ramat Gan (IL); Kenneth Nagin, Hamovil (IL)

(73) Assignee: International Business Machines Corporation, Armonk, NY (US)

(21) Appl. No.: 14/260,312

(22) Filed: Apr. 24, 2014

(51) Int. Cl. G05B 19/4097; G06F 17/50

(52) U.S. Cl. CPC G05B 19/4097; G06F 17/50

(57) ABSTRACT

Methods, apparatus and computer program products implement embodiments of the present invention that include loading a digital model to a digital manufacturing system having a manufacturing tolerance, and manufacturing, by the digital manufacturing system using the digital model, multiple objects. For each given object, one or more fingerprint measurements of the given object are collected from a fingerprint sensing device having a fingerprint resolution better than the manufacturing tolerance, and using the one or more fingerprint measurements, a unique digital fingerprint is created. The unique digital fingerprint can be stored to a provenance database. Subsequent to storing the unique digital fingerprints, one or more authentication measurements of an authentication object can be collected, and using the one or more authentication measurements, an authentication digital fingerprint can be created. The authentication object can be authenticated by locating a given unique digital fingerprint in the provenance database matching the authentication digital fingerprint.

### FIELD OF THE INVENTION

The present invention relates generally to digital manufacturing, and specifically to establishing and identifying unique digital fingerprints in order to very authenticity of digitally manufactured products.

### BACKGROUND

Advances in additive manufacturing (AM), all-purpose direct numerical control (DNC) centers, subtractive manufacturing (SM), CAD/CAM tools, web services, and cloud computing have enabled establishment of globally integrated supply chains that bring together designers of parts and products, design owners, AM and SM manufacturing enterprises, and distributors. This integrated supply network is referred to as Digital Manufacturing (DM). Advantages of DM include extreme agility and flexibility, thereby enabling on-demand creation of highly optimized integrated low inventory supply chains for global enterprises.

DM typically requires the following data in order to fabricate an object:
A digital model (also known as a “design”), e.g., a STereoLithography (STL) file that describes a geometry of an object.
Process information that describes pre-process, post-process, and quality assurance steps. Process information may comprise either machine readable instructions or human readable instructions.

The description above is presented as a general overview of related art in this field and should not be construed as an admission that any of the information it contains constitutes prior art against the present patent application.

### SUMMARY

There is provided, in accordance with an embodiment of the present invention a method, including loading a digital model to a digital manufacturing system having a manufacturing tolerance, manufacturing, by the digital manufacturing system using the digital model, multiple objects, and for each given object, collecting, from a fingerprint sensing device having a fingerprint resolution better than the manufacturing tolerance, one or more fingerprint measurements of the given object, creating, using the one or more fingerprint measurements, a unique digital fingerprint, and storing the unique digital fingerprint to a provenance database.

There is also provided, in accordance with an embodiment of the present invention an apparatus, including a digital manufacturing system having a manufacturing tolerance and including a memory, a manufacturing processor configured to load a digital model to the memory, and a fabrication module configured to manufacture, using the digital model, multiple objects. The apparatus also includes a digital fingerprint creation system including a fingerprint sensing device having a fingerprint resolution better than the manufacturing tolerance, and a fingerprint processor configured, for each given object, to collect, from the fingerprint sensing device, one or more fingerprint measurements of the given object, to create, using the one or more fingerprint measurements, a unique digital fingerprint, and to store the unique digital fingerprint to a provenance database.

There is further provided, in accordance with an embodiment of the present invention a computer program product, the computer program product including a non-transitory computer readable storage medium having computer readable program code embodied therewith, the computer readable program code including computer readable program code configured to load a digital model to a digital manufacturing system having a manufacturing tolerance, and upon manufacturing, by the digital manufacturing system using the digital model, multiple objects, computer readable program code configured, for each given object, to collect, from a fingerprint sensing device having a fingerprint resolution better than the manufacturing tolerance, one or more fingerprint measurements of the given object, to create, using the one or more fingerprint measurements, a unique digital fingerprint, and to store the unique digital fingerprint to a provenance database.

### BRIEF DESCRIPTION OF THE DRAWINGS

The disclosure is herein described, by way of example only, with reference to the accompanying drawings, wherein:

FIG. 1 is a block diagram that schematically illustrates a digital manufacturing system, in accordance with an embodiment of the present invention;

FIG. 2 is a block diagram of a digital fingerprint creation system and a digital fingerprint authentication system that are configured to interact with a provenance database, in accordance with an embodiment of the present invention;

FIG. 3 is a flow diagram that schematically illustrates a method of defining a digital fingerprint for a digitally manufactured object, in accordance an embodiment of the present invention;

FIG. 4 is a flow diagram that schematically illustrates a method of authenticating the digital fingerprint of the digitally manufactured object, in accordance an embodiment of the present invention;

FIG. 5 is a block diagram that schematically illustrates a system comprising an off-site provenance and authenticity tracking service (PATS) facility, in accordance with a first embodiment of the present invention; and

FIG. 6 is a block diagram that schematically illustrates the provenance and authenticity tracking service (PATS) facility, in accordance with a second embodiment of the present invention.

### DETAILED DESCRIPTION OF EMBODIMENTS

### Overview

In DM, objects can be designed using digital models (also referred to herein as designs) and the digital models can be traded in the marketplace. For example, design owners or licensed enterprises can transfer designs over the Internet to fabricators (also referred to herein as manufacturers) that use AM and/or SM in order to fabricate a specific number of objects from the digital design.

When producing objects using DM techniques, it is important to fully leverage the advantages of digital manufacturing without exposing the model owner and a legitimate manufacturer to the dangers of uncontrolled intellectual property (IP) leakage and counterfeit object fabrication. This can be accomplished by ensuring the following:
The object is manufactured using the original design.
The object is commissioned for fabrication by a legal design owner.
The object is manufactured by a certified manufacturer using materials, and using process and quality control according to the original bill of materials and engineering bill of materials.
The object is manufactured to order as part of a legitimate business to business (B2B) transaction.

In operation, it may not always by possible to identify a counterfeit object because a counterfeiter might use a fabrication machine with the same or higher fidelity (also referred to herein as resolution and tolerance) than a fabrication machine that was used to produce of the legitimate object. Thus, even the objective tests may not be able to tell the difference between an authentic object and an illegitimate replica.

Embodiments of the present invention provide methods and systems for defining and authenticating unique digital fingerprints (i.e., unique identifiers) for multiple digitally manufactured objects. In some embodiments, the digital manufacturing system has a manufacturing tolerance, and can manufacture the items using a single design. Upon manufacturing the objects, a fingerprint sensing device, having a fingerprint resolution better than the manufacturing tolerance, can collect one or more measurements of the given object, create, using the one or more measurements, a unique digital fingerprint, and store the unique digital fingerprint to a provenance database.

Subsequent to calculating and storing the unique digital fingerprints to the provenance database, additional embodiments of the present invention enable authentication of one of the objects that was manufactured by the digital manufacturing system. In the description herein, one of the objects manufactured by the digital manufacturing system may also be referred to as a legitimately manufactured object.

To authenticate a given legitimately manufactured object, an authentication system can collect, from an authentication sensor having an authentication resolution greater than or equal to the fingerprint resolution, one or more authentication measurements of the given legitimately manufactured object, create, using the one or more authentication measurements, an authentication digital fingerprint, and authenticate the legitimately manufactured object upon locating a given unique digital fingerprint in the provenance database matching the authentication digital fingerprint.

In addition to authenticating a given legitimately manufactured object, further embodiments of the present invention enable the authentication system to identify (i.e., “flag”) a counterfeit object. Upon collecting, from the second sensing device, one or more authentication measurements of a counterfeit object, the authentication system can create, using the one or more authentication measurements, an authentication digital fingerprint, and flag the counterfeit object upon failing to locate a given unique digital fingerprint in the provenance database matching the authentication digital fingerprint.

By implementing embodiments of the present invention, a commercial enterprise can provide a service that can dependably track the provenance of legitimately manufactured objects, and thereby help reduce injection of counterfeited physical objects fabricated via digital manufacturing technologies into supply networks monitored by the service.

When objects are manufactured under the supervision of the proposed service, the service can reliably associate, at the time of fabrication, a unique digital fingerprint with every object. Therefore, embodiments of the present invention can introduce a 1:1 correspondence between each legitimately manufactured object and its respective digital fingerprint. At a subsequent time, this 1:1 mapping can be used to track provenance, to identify a counterfeit object, to identify its fabricator, to designate the fabricator as compromised, and to isolate the compromised fabricator.

Additionally, embodiments of the present invention may provide:
Systems and methods for the service to directly control the manufacturing cycle of an object without directly transferring an explicit digital model (“design”) of an object or machine process instructions to the fabricator.
Systems and methods for digitally earmarking objects to trace provenance.
Systems and methods for identifying a match between an object and its digital fingerprint.
Systems and methods for intrusion detection (into supply network) that identifies compromised fabricators.

Benefits of embodiments of the present invention include, but are not limited to:
Creating disincentives for legitimate partners in a supply network to cheat.
Preventing illegitimate (i.e., “black market”) dealers to cheat on the clients of the proposed service.
Reducing the likelihood of clients of the service to inadvertently purchase counterfeit objects.
Reducing the risk of unauthorized access, at the fabricator, to IP associated with the object design and machine process instruction.

### System Description

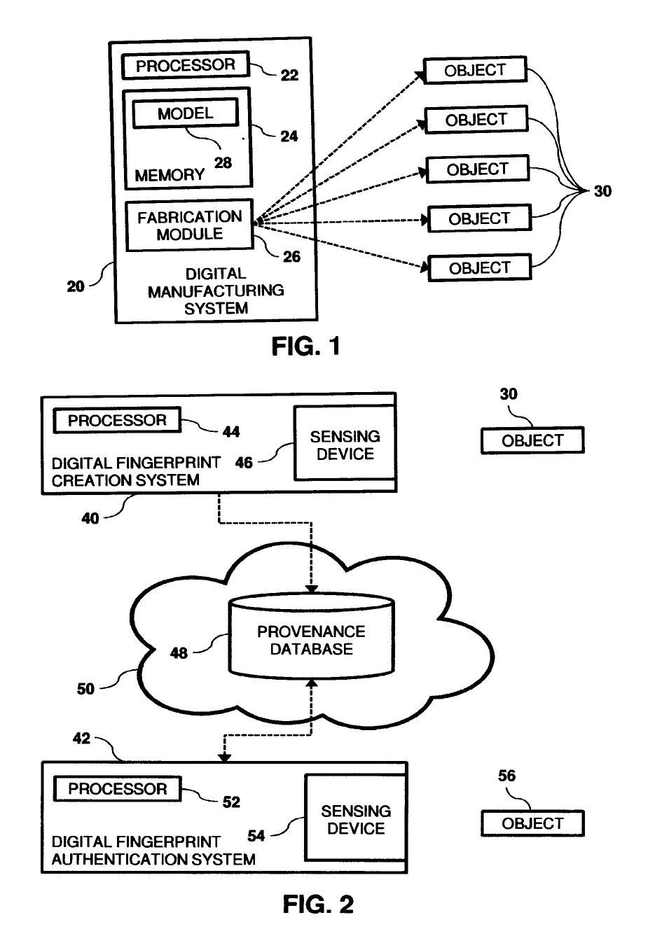

FIG. 1 is a block diagram that schematically illustrates a digital manufacturing system 20, in accordance with an embodiment of the invention. System 20 comprises a manufacturing processor 22, a memory 24 and a fabrication module that has a manufacturing tolerance, and is configured to digitally manufacture, using a digital model 28 that was loaded into the memory, multiple objects 30. Examples of fabrication module 26 include, but are not limited to, three-dimensional printers and computer numerical control (CNC) machines. Examples of digital models that system 20 can use to fabricate objects 30 include, but are not limited to:
Point cloud models.
Mesh models such as STereoLithography (STL) models, Virtual Reality Modeling Language (VRML) models, Wavefront (OBJ) models, Polygon File Format (PLY) models (also known as Stanford Triangle Format models).
Non-Uniform Rational B-Splines (NURBS) surfaces such as Initial Graphics Exchange Specification (IGES) files, STEP files and Autodesk DWG™ files.

FIG. 2 is a block diagram that schematically illustrates a digital fingerprint creation system 40 and a digital fingerprint authentication system 42 that are configured to manage provenance and authenticity of objects 30, in accordance with an embodiment of the present invention.

Digital fingerprint creation system 40 comprises a fingerprint processor 44 and a fingerprint sensing device 46 having a fingerprint resolution better than (i.e., greater than) the manufacturing tolerance. For example, the fabrication module may have a manufacturing tolerance of 25 microns, and the fingerprint sensing device may have a fingerprint resolution of 15 microns when analyzing a given object 30.

As explained hereinbelow, processor 44 collects (i.e., scans), from sensing device 46, one or more fingerprint measurements for a given object 30, calculates a unique digital fingerprint (not shown) for the given object, and stores the unique digital fingerprint to a provenance database 48. In the configuration shown in FIG. 2 provenance database 48 is stored in a computing cloud 50. In alternative embodiments, the provenance database can be stored locally to one of systems 20, 40 and 42.

While the configuration in FIGS. 1 and 2 shows digital manufacturing system 20 configured to fabricate objects 30 and digital fingerprint creation system 40 configured to create and store unique digital fingerprints to provenance database 48, other configurations are considered to be within the spirit and scope of the present invention. For example, sensing device 46 may be included in digital manufacturing system 20, and the functionality of digital fingerprint creation system may be incorporated into the digital manufacturing system.

Digital fingerprint authentication system 42 comprises an authentication processor 52 and an authentication sensing device 54 that has an authentication resolution greater than or equal to the fingerprint resolution of sensing device 46. In operation, processor 52 collects, from sensing device 54, one or more authentication measurements for an authentication object 56, calculates an authentication fingerprint (not shown) for the authentication object, and determines, based on the authentication fingerprint and the digital fingerprints stored in provenance database 48, whether authentication object 56 comprises a given (i.e., a legitimate) object 30 or a counterfeit object. Object 56 comprises a given object 30 or a counterfeit object that was scanned by sensing device 54 for authentication purposes.

In embodiments of the present invention, sensing devices 46 and 54 are configured to collect, for a given object 30, information such as:
Three-dimensional coordinates of a surface of the given object.
Response to a signal such as an electric current applied to the given object.
A weight of the given object.
A volume of the given object.
A density of the given object.
Mass spectrometry data.
Terahertz imaging data.

Processors 22, 44 and 52 typically comprise a general-purpose computer, which are programmed in software to carry out the functions described herein. The software may be downloaded to systems 20, 40 and 42 in electronic form, over a network, for example, or it may be provided on non-transitory tangible media, such as optical, magnetic or electronic memory media. Alternatively, some or all of the functions of processors 22, 44 and 52 may be carried out by dedicated or programmable digital hardware components, or using a combination of hardware and software elements.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### Provenance Management

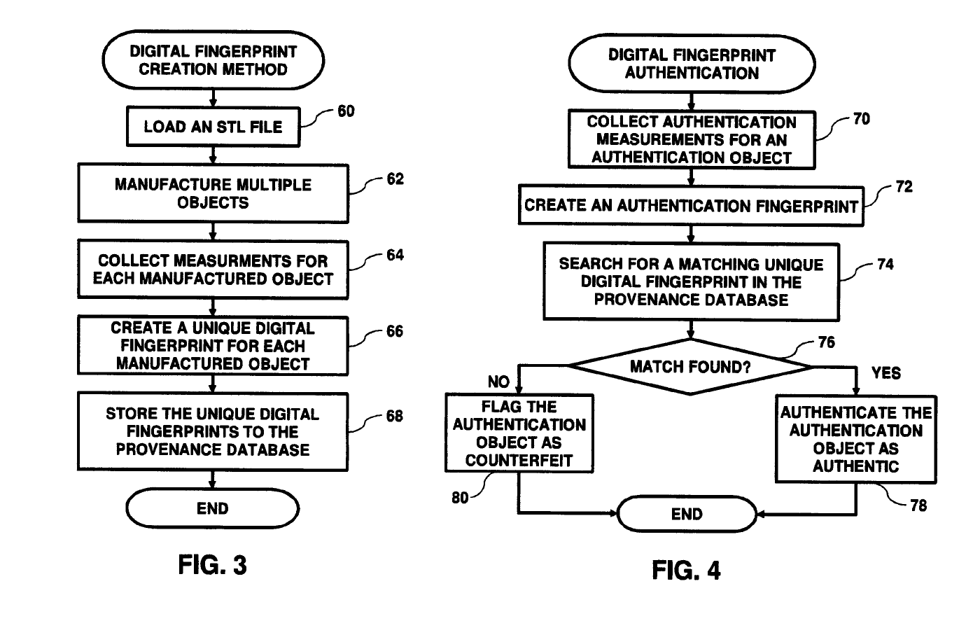

FIG. 3 is a flow diagram that schematically illustrates a method of defining a digital fingerprint for a given digitally manufactured object 30, in accordance an embodiment of the present invention. In a load step 60, processor 22 loads a digital model 28 to memory 24, and in a manufacturing step 62, fabrication module 26 manufactures multiple objects 30 based on the parameters in digital model 28.

For each given object 30, processor 22 collects one or more fingerprint measurements from sensing device 46 in a collection step 64, creates, using the collected one or more fingerprint measurements, a unique digital fingerprint in a creation step 66, and stores the unique digital fingerprint to provenance database 48 in a store step 68, thereby completing the method. While manufacturing step 62 and collection step 64 as separate steps, integrating steps 62 and 64 may be integrated into a single fabrication step in embodiments where digital manufacturing system 20 has continuous in situ scanning capabilities.

To create a given unique digital fingerprint, processor 44 can collect, from sensing device 46 natural “noise” on the given object that is produced by the fabrication process itself, and create a digital fingerprint based on this noise. In embodiments of the present invention, the noise comprises manufacturing imperfections that are within the manufacturing tolerance, but that can be detected at the fingerprint resolution. As described supra, sensing device 46 is configured to scan the completed given object at a fingerprint resolution that is higher than the manufacturing tolerance(s) of the fabrication module 26.

In embodiments herein, the terms “scan” and “collect” describe capturing information that can define the given object. The information can be a digital image obtained from a three-dimensional scan and additional object measurements such as weight and density. The higher sensitivity of sensing device 46 is due to the fact that any physical object conforms to its specification only within the manufacturing tolerances of the machine that was used to manufacture it, and a higher sensitivity scanning device can capture the noise that the manufacturing device typically cannot reproduce.

In some embodiments, processor 44 can randomly select points (vectors) in the collected measurements to form a 3×N matrix S₁, where N is the number of points selected from the scanning representation. The fingerprint resolution of sensing device 46 can be denoted as

ε₁=(ε₁^{x}, ε₁^{y}, εhd 1^{z}) (1)

along X (horizontal), Y (vertical), and Z (depth) axes. In some embodiments, the respective digital fingerprint of the object may comprise the pair (S₁, ε₁).

FIG. 4 is a flow diagram that schematically illustrates a method of authenticating the digital fingerprint of the digitally manufactured object, in accordance an embodiment of the present invention. In a collection step 70, processor 52 collects, from sensing device 54, authentication measurements for authentication object 56, and creates, using the collected authentication measurements, an authentication fingerprint in a creation step 72. The authentication fingerprint can be created using embodiments described supra for creating the each respective unique digital fingerprint for each given object 30.

In a search step 74, processor 52 searches provenance database 48 for a given unique digital fingerprint that matches the authentication fingerprint. In a first comparison step 76, if processor 52 finds a match in provenance database 48, then the authentication processor authenticates object 56 as authentic in an authentication step 78, and the method ends. However, if processor 52 fails to find a match in provenance database 48, then the authentication processor flags object 56 as counterfeit in a counterfeit detection step 80, and the method ends.

In some embodiments finding a match comprises locating a given unique fingerprint that is within an authentication tolerance of the authentication fingerprint. Likewise, failing to locate a given unique digital fingerprint in the provenance database matching the authentication digital fingerprint comprises failing to locate any unique digital fingerprint in the provenance database that is within the authentication tolerance of the authentication digital fingerprint.

Therefore, a counterfeit object that was fabricated from a stolen design can be identified using embodiments described herein, since the original design typically does not contain the production noise described above. Additionally, embodiments of the present invention can help mitigate the possibility of introducing counterfeits into the legitimate value chain by implementing an intrusion detection method that leverages the 1:1 correspondence between a given object 30 and its respective unique digital fingerprint.

If more than one authentication objects 56 are identified with the same digital fingerprint, flagging the authentication objects as counterfeit may comprise conveying, to a user, a notification that counterfeit objects introduced. Authentication objects with identical digital fingerprints can be created by using a production machine (not shown) whose tolerance is greater than the manufacturing tolerance of system and better than (i.e., greater than) the fingerprint resolution of system 40. In such cases, a provenance trace of the given object associated with the compromised digital fingerprint can help identify which fabricator has been compromised.

In step 70, a scan S₂ of the authentication object with the sensitivity of scanning ε₂≦ε₁ can be performed by an owner of a given object 3, or a party acting on the owner's behalf. A pair (S2, ε2) can then be analyzed by authentication system 42. The authentication system can calculate a matching matrix

D=|S₁−S₂| (2)

and classify the authentication object as authentic with probability p if and only if there exist sufficiently many

dᵢⱼ:dᵢⱼ≦ε₁ (3)

where value p is directly proportional to the number of sample points.

### Provenance and Authenticity Tracking Service (PATS)

In some embodiments, upon fabricating objects 30, processor can convey the collected measurements and the fingerprint resolution to an off-site service. Subsequently, authentication system 42 can authenticate a given authentication object 56 by conveying the authentication measurements to the external service, and responsively receive a message from the service indication if the authentication object is authentic or counterfeit.

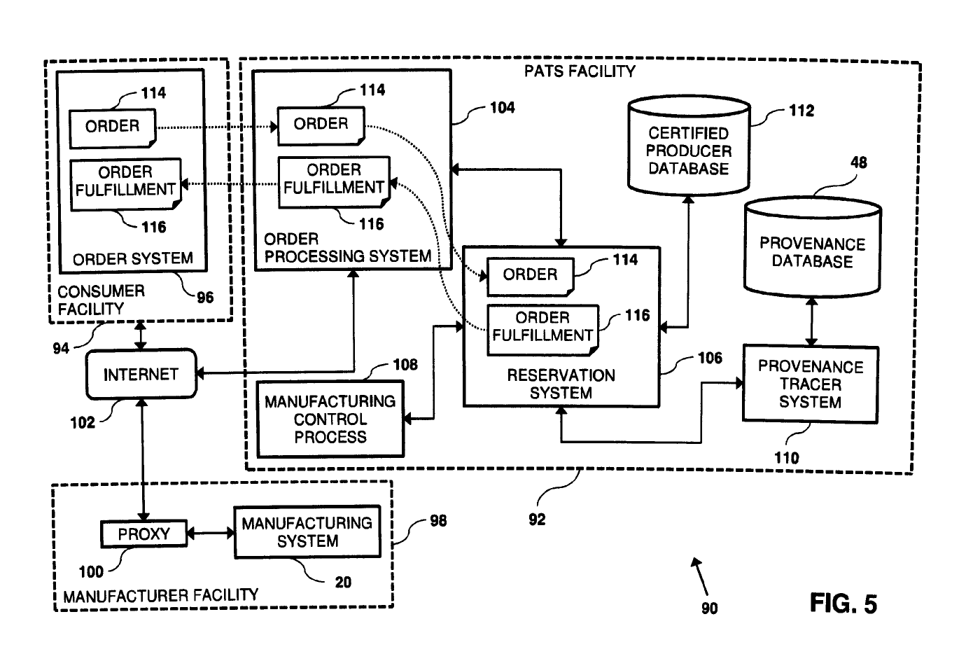

FIG. 5 is a block diagram that schematically illustrates a system 90 comprising an off-site provenance and authenticity tracking service (PATS) facility 92, in accordance with a first embodiment of the present invention. In the following description, PATS facility 92 may be used to assign digital fingerprints for digitally manufactured objects 30. FIG. 5 shows components that can be used to create a “genesis block” of a provenance trace, i.e., the first provenance record in a provenance trace for a given object 30. A legal provenance trace typically has to have exactly one genesis record that is created at the time of object manufacturing from a given design.

In addition to PATS facility 92, system 90 comprises a consumer facility 94 comprising an order system 96, and a manufacturer facility 98 comprising manufacturing system 20 and a proxy 100 is described hereinbelow. In operation, PATS facility 92, consumer facility 94 and manufacturer facility can communicate with each other via Internet 102. In alternative embodiments, the facilities in FIG. 5 can communicate with each other over any type of local area network or wide area network (not shown).

In addition to provenance database 48, PATS facility 92 comprises an order processing system 104, a reservation system 106, a manufacturing control process 108 executing within the PATS facility, a provenance tracer system 110, and a certified producer database 112, whose functionalities are described hereinbelow.

In the configuration shown in FIG. 5, the digital fingerprint creation algorithm can act as a “black box”, so a specific choice of the scan areas on objects 30 and/or 56 can be kept private within PATS facility 92. In order to authenticate a given object 30, a user can scan the object with a suitable scanning device (e.g., device 54) and transmit the scan data to PATS facility 92. Using embodiments described herein, PATS facility 92 can compare this scan with the given object's original scan. In the absence of a suitable scanning device, a user of the PATS facility can ship the given object to the PATS facility premises for physical inspection.

In the description herein, a fabricator that manufactures an object on demand may also be referred to as a “producer”, and to the entity that consumes the objects fabricated by a producer may also be referred to as a “consumer”. The producers and the consumer can both be customers of PATS facility 92. In the description herein:
A customer of PATS facility 92 who wants to verify authenticity and provenance of a given authentication object 56 may be referred to as an “object owner”.
The ownership transfer of any given object 30 is performed via an e-Commerce transaction management system trusted by PATS facility 92.
Owners of objects 30 can authenticate to the e-Commerce transaction management system using methods known in the art.
Each given object 30 has a single legitimate owner at any point in time, and the ownership transfer is recorded in the given object's provenance record managed by PATS facility 92.

In the configuration shown in FIG. 5, orders for one or more objects 30 can be conveyed from consumer facility 94 to manufacturer facility 98 via PATS facility 92. Consumer facility 94 places an order 114 that contains a model 28 and process instructions intended for execution by one of the PATS facility's certified producers, in this case manufacturer facility 98.

In response to receiving the order, PATS facility 92 spawns (a new) manufacturing control process 108 that directly interacts with the fabrication module 26 in facility 98. In some embodiments, making the manufacturer facility's manufacturing equipment directly available to PATS facility 92 can be a requirement for being a customer of the PATS facility that us acting in a producer role.

In one embodiment, manufacturing control process 108 interacts with remote manufacturing facility 98 and its respective manufacturing system(s) 20 directly indirectly via proxy 100. Manufacturing control process 108 controls production of objects 30, so that the manufacturing facility never actually has direct contact with object's model 28. In this configuration, the design specifications can be streamed directly to the manufacturing system(s).

As part of the process, a digital fingerprint of each given object is created and stored in the object's provenance trace in the provenance database. In addition to the digital fingerprint, a given object's provenance trace can contain information relevant to object production including a reference to the originating design, design owner, object owner, fabrication facility, production machine, production date, all previous object owners and information about the ownership transfers, etc.

In the example shown in FIG. 5, consumer facility 94 (also referred to herein as the consumer) submits, to order processing system, 104, order 114 to produce one or more objects 30. The order contains information such as a legitimate digital model (e.g., model 28), a unique customer generated reference identifier of the model, machine readable process instructions, human readable process instructions, unique part number, a producer, suitable production machine tolerances, intended owner information, and production terms such as price, completion date, etc.

Upon receiving order 114, system 104 parses the order and conveys it to reservation system 106. Upon receiving order 114 from order processing system 104, reservation system 106 validates that the producer is certified to produce parts for the consumer, and spawns manufacturing control process 108 that is configured to initiate and monitor the part creation.

Manufacturing control process 108 communicates with manufacturer facility 98 (also referred to herein as the producer) via proxy 100. A human operator or a rule engine at manufacturer facility 98 approves the reservation through the Proxy's application program interface) API. Manufacturer facility 98 may skip manual approval for preferred customers by configuring its order approval policies via a policy engine, or in cases when a negotiation took place between the consumer and the producer, prior to the order's placement.

In the configuration shown in FIG. 5, once the order is approved by the producer a message is conveyed from the producer to the PATS facility and an order confirmation 116 is conveyed to the consumer.

Once the order is approved, the manufacturing control process conveys obfuscated versions of model 28 and machine processing instructions and human readable processing instructions to the producer. In some embodiments, proxy 100 can control the fabrication process over the producer's local network (not shown) and report the fabrication progress to the manufacturing control process.

Additionally, in embodiments where the producer has multiple (non-identical) manufacturing systems 20, the proxy can choose a given manufacturing system 20 whose respective specifications meet the required production tolerances. Upon detecting that the given manufacturing system is available, the proxy can deobfuscate model 28 and any machine readable process instructions, and stream them to the given manufacturing system.

Upon fabricating a given object, the given object can be scanned as described hereinabove, its scanned representation returned to the proxy, and the proxy can then convey, to the manufacturing control process, information such as the given object's completion, its scanned representation, the manufacturing system's identification and specification, and the scanning device's identification and specification.

Upon receiving the information, the manufacturing control process can report the given object's completion, report additional information such as its scanned representation to the reservation system, and the reservation system can responsively convey a request to the provenance tracer system to update the given object's provenance record. In response to receiving the request, the provenance tracer system updates the provenance database with a provenance record with the “genesis block” that includes information such as the part identifier, its respective digital fingerprint created from the scanned representation, the producer's identifier, reference to the original design and process instructions, the identification and specifications of the given manufacturing system that produced the given object, and an identifier and specifications for sensing device 54.

Finally, to complete the manufacturing process, the reservation system reports the order fulfillment to the order processing system, and the order processing system reports the order fulfillment to the consumer.

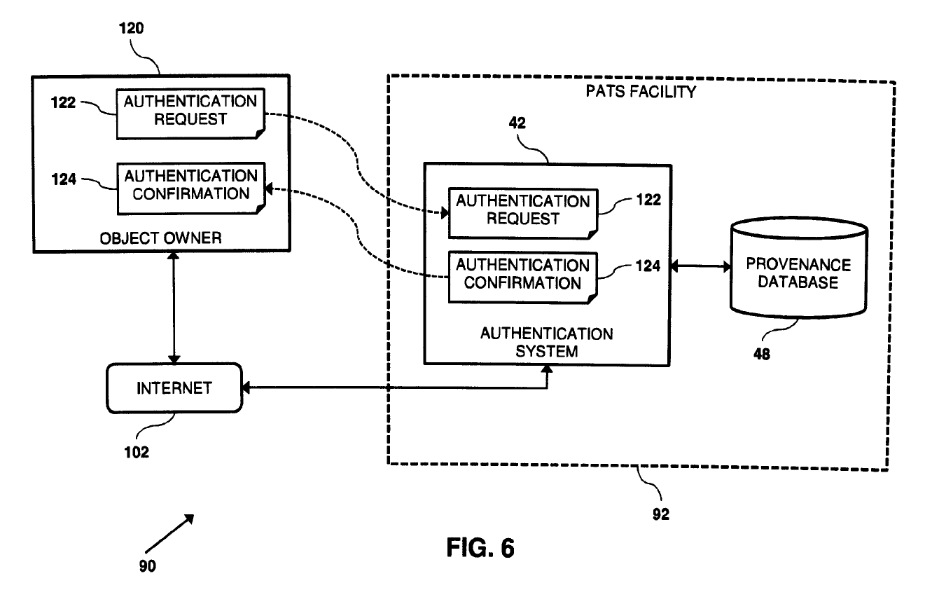

FIG. 6 is a block diagram that schematically illustrates a system 90 comprising an off-site provenance and authenticity tracking service (PATS) facility 92, in accordance with a second embodiment of the present invention. In the configuration shown in FIG. 6, PATS facility 92 may be used to provide authentication services, for an owner 120 of one or more objects 30. As shown in the figure, PATS facility 92 comprises authentication system 42 that communicates with owner 120 via Internet 102.

In the example shown in FIG. 6, owner 120 conveys, to authentication processor 52, an authentication request 122 for a given object 30. The authentication request contains information such the scan representation of the authentication object and its part number. The scan is typically performed by owner 120 or by a PATS service such as PATS facility 92.

Upon receiving the authentication request, authentication processor 52 parses the authentication request and reads the given object's provenance record from provenance database 48, compares the original scan representation (i.e., for the given object) against the one received from the owner, and conveys to owner the results of the comparison in an authentication confirmation record 124.

The flowchart(s) and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method, comprising:
loading a digital model to a digital manufacturing system having a manufacturing tolerance;
manufacturing, by the digital manufacturing system using the digital model, multiple objects; and
for each given object:
collecting, from a fingerprint sensing device having a fingerprint resolution better than the manufacturing tolerance, one or more fingerprint measurements of the given object;
creating, using the one or more fingerprint measurements, a unique digital fingerprint; and
storing the unique digital fingerprint to a provenance database.

2. The method according to claim 1, and comprising subsequent to storing the unique digital fingerprints:
collecting, from an authentication sensing device having an authentication resolution equal to or greater than the fingerprint resolution, one or more authentication measurements of one of the multiple objects;
creating, using the one or more authentication measurements, an authentication digital fingerprint; and
authenticating the one of the multiple objects upon locating a given unique digital fingerprint in the provenance database matching the authentication digital fingerprint.

3. The method according to claim 2, wherein the fingerprint measurements and the authentication measurements are selected from a list consisting of three-dimensional coordinates of a surface of the given object, a response to a signal applied to the given object, a weight of the given object, a volume of the given object, a density of the given object, mass spectrometry data and terahertz imaging data, and wherein the digital manufacturing system comprises a fabrication module selected from a list consisting of a three-dimensional printer and a computer numerical control machine.

4. The method according to claim 2, wherein the given unique digital fingerprint in the provenance database matching the authentication digital fingerprint comprises the given unique digital fingerprint being within an authentication tolerance of the authentication digital fingerprint.

5. The method according to claim 1, and comprising subsequent to storing the unique digital fingerprints:
collecting, from an authentication sensing device having an authentication resolution equal to or greater than the fingerprint resolution, one or more authentication measurements of a counterfeit object;
creating, using the one or more authentication measurements, an authentication digital fingerprint; and
flagging the counterfeit object upon failing to locate a given unique digital fingerprint in the provenance database matching the authentication digital fingerprint.

6. The method according to claim 5, wherein flagging the counterfeit object comprises identifying a fabricator of the counterfeit object, designating the identified fabricator as compromised, isolating the identified fabricator.

7. The method according to claim 5, wherein the fingerprint measurements and the authentication measurements are selected from a list consisting of three-dimensional coordinates of a surface of the given object, a response to a signal applied to the given object, a weight of the given object, a volume of the given object, a density of the given object, mass spectrometry data and terahertz imaging data, and wherein the digital manufacturing system comprises a fabrication module selected from a list consisting of a three-dimensional printer and a computer numerical control machine.

8. The method according to claim 5, wherein failing to locate a given unique digital fingerprint in the provenance database matching the authentication digital fingerprint comprises failing to locate any unique digital fingerprint in the provenance database that is within an authentication tolerance of the authentication digital fingerprint.

9. An apparatus, comprising:
a digital manufacturing system having a manufacturing tolerance and comprising:
a memory;
a manufacturing processor configured to load a digital model to the memory; and
a fabrication module configured to manufacture, using the digital model, multiple objects; and
a digital fingerprint creation system comprising:
a fingerprint sensing device having a fingerprint resolution better than the manufacturing tolerance; and
a fingerprint processor configured, for each given object, to collect, from the fingerprint sensing device, one or more fingerprint measurements of the given object, to create, using the one or more fingerprint measurements, a unique digital fingerprint, and to store the unique digital fingerprint to a provenance database.

10. The apparatus according to claim 9, and comprising a digital fingerprint authentication system comprising:
an authentication sensing device having an authentication resolution equal to or greater than the fingerprint resolution; and
an authentication processor configured, subsequent to storing the unique digital fingerprints, to collect, from the authentication processor, one or more authentication measurements of one of the multiple objects, to create, using the one or more authentication measurements, an authentication digital fingerprint, and to authenticate the one of the multiple objects upon locating a given unique digital fingerprint in the provenance database matching the authentication digital fingerprint.

11. The apparatus according to claim 10, wherein the fingerprint measurements and the authentication measurements are selected from a list consisting of three-dimensional coordinates of a surface of the given object, a response to a signal applied to the given object, a weight of the given object, a volume of the given object, a density of the given object, mass spectrometry data and terahertz imaging data.

12. The apparatus according to claim 10, wherein the given unique digital fingerprint in the provenance database matching the authentication digital fingerprint comprises the given unique digital fingerprint being within an authentication tolerance of the authentication digital fingerprint.

13. The apparatus according to claim 9, and comprising a digital fingerprint authentication system comprising:
an authentication sensing device having an authentication resolution equal to or greater than the fingerprint resolution; and
an authentication processor configured, subsequent to storing the unique digital fingerprints, to collect, from the authentication sensing device, one or more authentication measurements of a counterfeit object, to create, using the one or more authentication measurements, an authentication digital fingerprint, and to flag the counterfeit object upon failing to locate a given unique digital fingerprint in the provenance database matching the authentication digital fingerprint.

14. The apparatus according to claim 13, wherein the authentication processor is configured to flag the counterfeit object by identifying a fabricator of the counterfeit object, designating the identified fabricator as compromised, and isolating the identified fabricator.

15. The apparatus according to claim 13, wherein the fingerprint measurements and the authentication measurements are selected from a list consisting of three-dimensional coordinates of a surface of the given object, a response to a signal applied to the given object, a weight of the given object, a volume of the given object, a density of the given object, mass spectrometry data and terahertz imaging data.

16. The apparatus according to claim 13, wherein the authentication processor is configured to fail to locate a given unique digital fingerprint in the provenance database matching the authentication digital fingerprint by failing to locate any unique digital fingerprint in the provenance database that is within an authentication tolerance of the authentication digital fingerprint.

17. The apparatus according to claim 9, wherein the digital manufacturing system comprises a fabrication module selected from a list consisting of a three-dimensional printer and a computer numerical control machine.

18. A computer program product, the computer program product comprising:
a non-transitory computer readable storage medium having computer readable program code embodied therewith, the computer readable program code comprising:
computer readable program code configured to load a digital model to a digital manufacturing system having a manufacturing tolerance; and
upon manufacturing, by the digital manufacturing system using the digital model, multiple objects, computer readable program code configured, for each given object:
to collect, from a fingerprint sensing device having a fingerprint resolution better than the manufacturing tolerance, one or more fingerprint measurements of the given object;
to create, using the one or more fingerprint measurements, a unique digital fingerprint; and
to store the unique digital fingerprint to a provenance database.

19. The computer program product, according to claim 18, and comprising computer readable program code configured subsequent to storing the unique digital fingerprints:
to collect, from an authentication sensing device having an authentication resolution equal to or greater than the fingerprint resolution, one or more authentication measurements of one of the multiple objects;
to create, using the one or more authentication measurements, an authentication digital fingerprint; and
to authenticate the one of the multiple objects upon locating a given unique digital fingerprint in the provenance database matching the authentication digital fingerprint.

20. The computer program product, according to claim 18, and comprising computer readable program code configured subsequent to storing the unique digital fingerprints:
to collect, from an authentication sensing device having an authentication resolution equal to or greater than the fingerprint resolution, one or more authentication measurements of a counterfeit object;
to create, using the one or more authentication measurements, an authentication digital fingerprint; and
to flag the counterfeit object upon failing to locate a given unique digital fingerprint in the provenance database matching the authentication digital fingerprint.
